(19) United States
(12) Patent Application Publication
(10) Pub. No.: US 2011/0193312 A1
(43) Pub. Date: Aug. 11, 2011

(54) Drive Apparatus

(76) Inventor: John Fabian, Glendale, CA (US)

(21) Appl. No.: 12/703,098

(22) Filed: Feb. 9, 2010

(51) Int. Cl. B62M 1/04; F16H 19/06

(52) U.S. Cl. 280/252; 74/37

(57) ABSTRACT

A drive apparatus for converting a substantially linear drive force to a rotary propulsive force, the apparatus includes a track member and a pedal slidingly engaging the track member. The pedal is movable between first and second positions. The apparatus further includes an axle. A unidirectional clutch mechanism is coupled to the pedal and the axle. The clutch operably engages the power axle when a substantially linear force is applied in moving the pedal from the first position to the second position such that a rotary propulsive force is produced by the axle.

### BACKGROUND OF INVENTION

This application relates generally to a drive apparatus. More specifically, this application discloses a drive apparatus that converts a substantially linear driving force to a rotary propulsive force that may be used in a variety of applications such as to generate the propulsive force in a transportation device.

### SUMMARY

This application discloses a drive apparatus for converting a substantially linear driving force to a rotary propulsive force. The apparatus is of simple construction and can be used in a variety of applications including in standard bicycles, tricycles, reclining bicycles, personal watercraft such as paddle boats, scooters and any other similar transportation apparatus that uses a rotational force as a means to propel the transportation apparatus forward. The drive apparatus can also be used in stationary exercise devises such at stationary bikes, stair climbers, and any devices that utilize a reciprocating substantially linear force as part of the exercise regimen.

In particular, this disclosure provides a drive apparatus for converting a substantially linear drive force to a rotary propulsive force, the apparatus comprising: a track member; a pedal slidingly engaging the track member, the pedal movable between first and second positions; an axle; and a unidirectional clutch mechanism coupled to the pedal and coupled the axle, wherein the clutch operably engages the axle when a substantially linear force is applied in moving the pedal from the first position to the second position such that a rotary propulsive force is produced by the axle.

This disclosure also provides a drive apparatus for converting a substantially linear drive force to a rotary propulsive force, the apparatus comprising: a first track member; a first pedal slidingly engaging the track member, the first pedal movable between first and second positions; a second track member; a second pedal slidingly engaging the track member, the second pedal movable between first and second positions; an axle; a first unidirectional clutch mechanism coupled to the first pedal and coupled the axle, wherein the first clutch operably engages the axle when a substantially linear force is applied in moving the first pedal from the first position to the second position such that a rotary propulsive force is produced by the axle; and a second unidirectional clutch mechanism coupled to the second pedal and coupled the axle, wherein the second clutch operably engages the axle when a substantially linear force is applied in moving the second pedal from the first position to the second position such that a rotary propulsive force is produced by the axle.

### BRIEF DESCRIPTION OF THE DRAWINGS

The drawings, when considered in connection with the following description, are presented for the purpose of facilitating an understanding of the subject matter sought to be protected.

FIG. 1 is a schematic environmental view of a transportation device having a drive apparatus;

FIG. 2 is a schematic top view of the transportation device of FIG. 1;

FIG. 3 is a schematic cross-sectional top-view of a drive apparatus; and

FIG. 4 is a schematic perspective view of a track member and pedal.

### DETAILED DESCRIPTION

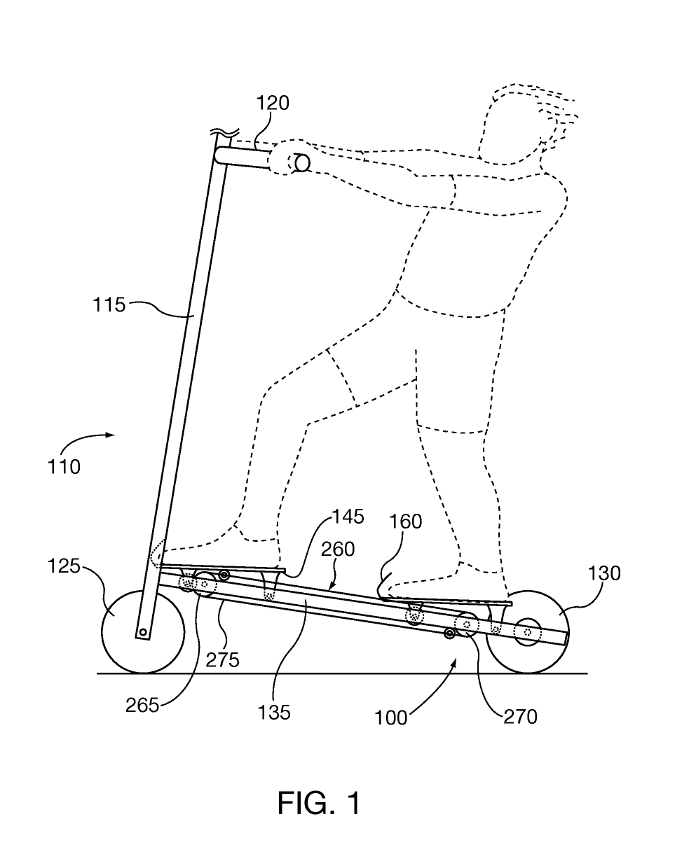

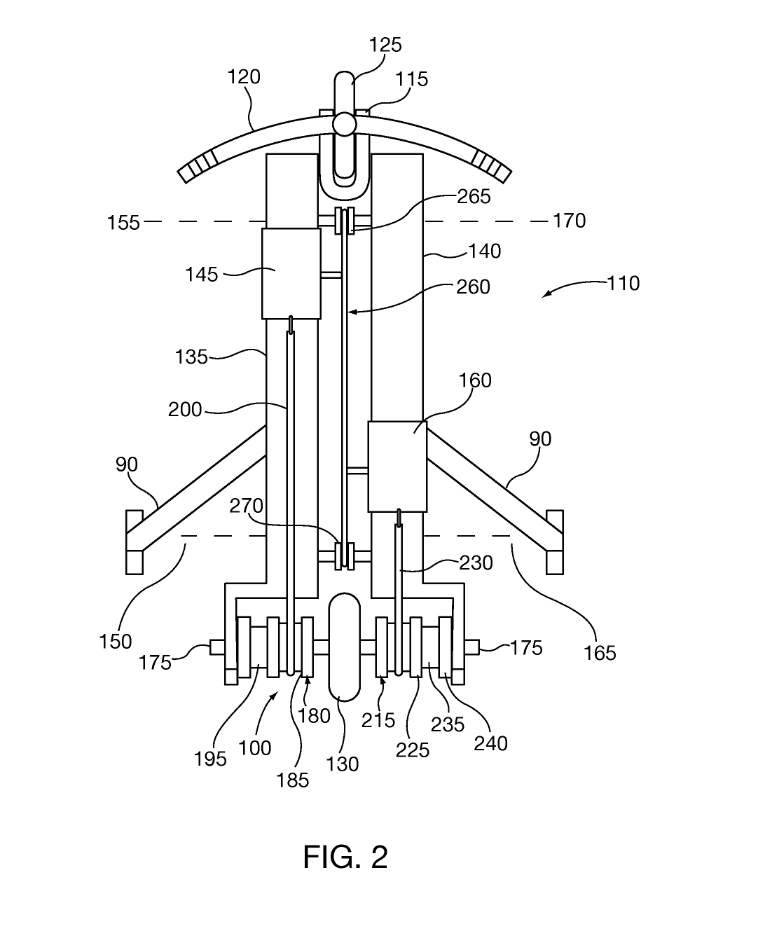

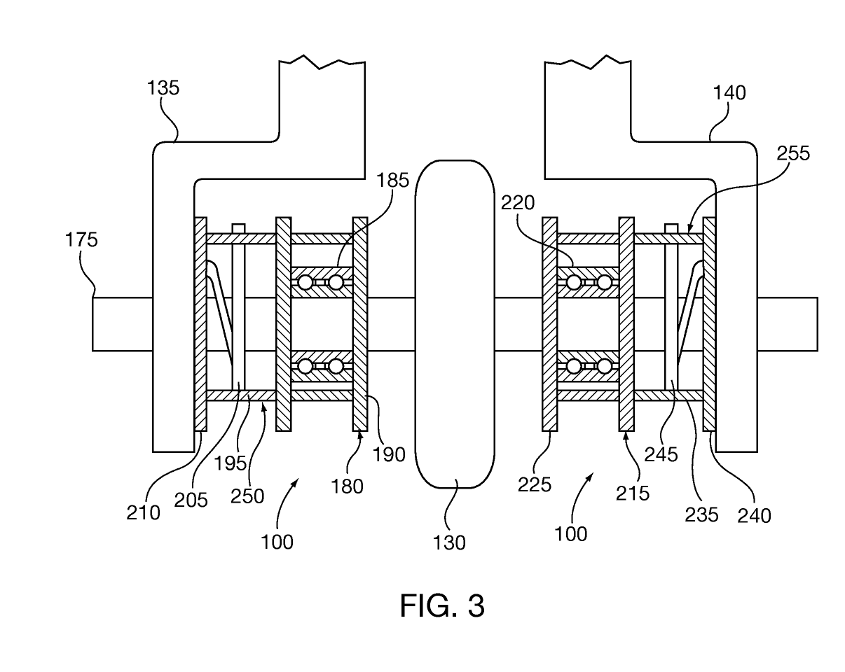

Referring now to FIGS. 1-4, shown therein and generally designated by the reference character 100 is an embodiment of the drive apparatus 100 constructed in accordance with the following description. The drive apparatus 100 is shown incorporated in a transportation device 110, however, it should be appreciated that the drive apparatus may be incorporated in a scooter, a tricycle, a reclining bicycle or any other similar transportation device that utilizes a rider's leg movement to propel the transportation device in a desired direction. The illustrative transportation device 110 generally includes a front frame 115, handle bars 120 coupled to the front frame 115, a front wheel 125, and a rear wheel 130. The device 110 may also include one or more stabilizing wheel assemblies 90 to assist the user with balance and maintain the device 110 in a substantially upright position. It will be understood that the forgoing components are illustrative only and are not intended to be limiting in any way.

The drive apparatus 100 includes a first track member 135 and a second track member 140. Each track 135, 140 is coupled to the front frame 115 and extend rearwardly towards the rear wheel 130. Each track 135, 140 may be releasably engaged to the front frame 115 whereby the grade or angle of each track 135, 140 relative to the ground may be adjusted. For example, and without limitation, each track 135, 140 may be adjusted between a substantially horizontal orientation and an orientation at approximately 45-degrees relative to the ground (or a substantially horizontal reference line). Thus, a user may selectively adjust the angle of each track 135, 140 in order to adjust the physical effort the user must input to propel the transportation device 110. Also, the rear portion of each track member 135, 140 rotatably engage an axle 175.

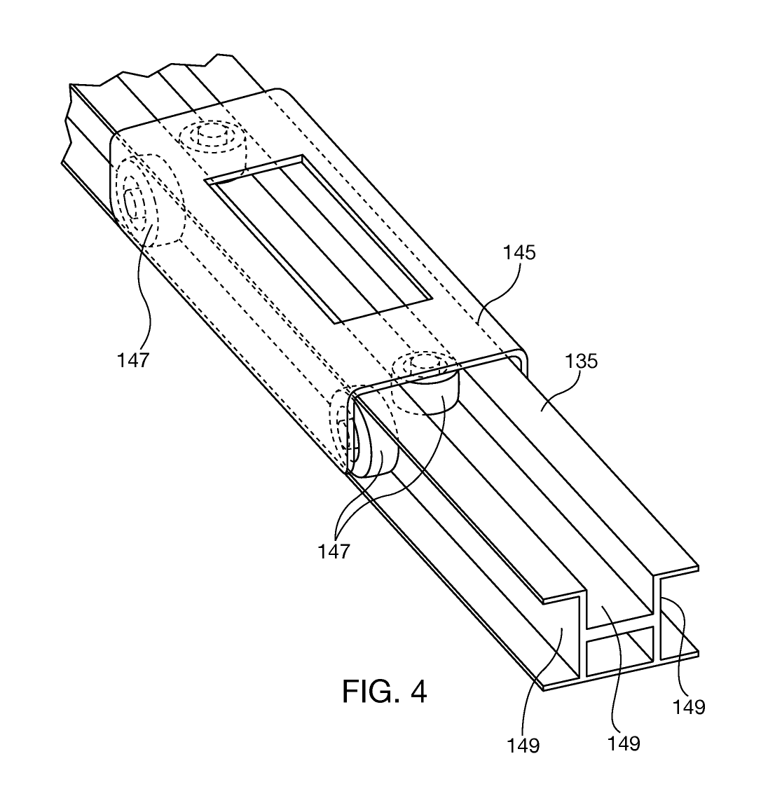

A first pedal 145 is in sliding engagement with the first track member 135 and movable between a first position 150 and a second position 155. As best shown in FIG. 4, the first pedal 145 may include one or more wheel members 147. The wheel members 147 may be oriented in a horizontal and/or vertical orientation and operable to slidingly engage the track member 135. It will be understood that the wheel members may be in any suitable orientation and remain within the scope of the present disclosure. The first track member 135 may include one or more tracks 149 disposed thereabouts and configured to slidingly receive each of the first pedal wheel members 147. It will, however, be appreciated that the pedal 145 and track member 135 may have any suitable configuration and remain within the scope of the present disclosure. Similarly, the second pedal 160 is in sliding engagement with the second track member 140 and movable between a first position 165 and a second position 170. The second pedal 160 and second track member 140 may be similarly configured to the first track member 135 and first pedal 145 as shown in FIG. 4; however, it will be appreciated that the second track member 140 and second pedal 160 may have any suitable configuration and remain within the scope of the present disclosure.

The drive apparatus 100 also includes a first unidirectional clutch mechanism 180. The unidirectional clutch 180 mechanism includes a unidirectional clutch bearing 185. The unidirectional clutch bearing 185 is coaxially disposed within and coupled to a spool 190. The axle 175 is coaxially disposed within the spool 190 and clutch bearing 185. The unidirectional clutch bearing 185 is configured to operably engage the axle 175 when the bearing 185 is rotated in one direction and disengage the axle 175 when the bearing 185 is rotated in the opposite direction. A belt 200 extends from the spool 190 to the first pedal 145. While the illustrative embodiment employs a belt 200, it will be appreciated that any suitable device or mechanism may be employed and remain within the scope of the present disclosure; for example, and without limitation, a rope, sting, spring or any other suitable device or mechanism may extend from the spool 190 to the first pedal 145.

When a user applies a linear force to the first pedal 145 to move the first pedal 145 from the first pedal first position 150 to the first pedal second position 155, the belt 200 is unwound from the spool 190 whereby the spool 190 and the clutch bearing 185 are rotated in a direction that causes the clutch bearing 185 to engage the axle 175 such that the axle 175 is rotated and a rotary propulsive force is imparted to the rear wheel 130. When a user applies a linear force to the first pedal 145 to move the first pedal 145 from the first pedal second position 155 to the first pedal first position 150, the clutch bearing 185 disengages the axle 175 and the axle 175 is not rotated therefrom.

In one embodiment, the apparatus 100 includes a first biasing system 250 comprising a housing 195, a resilient member 205 and a plate 210. The housing 195 extends from the spool 190. The interior of the housing 195 is encased by the plate 210. The plate 210 is rigidly coupled to the rear portion of the first track member 135 such that the plate does not rotate when the axle is rotating. While the plate 210 is rigidly coupled to the rear of the first track 135, it will be appreciated that the plate 210 may be coupled to any stationary (relative to the rotation of the spool 190) item or device and remain within the scope of the present disclosure. The resilient member 205, such as a spiral-torsion spring, is disposed within the housing 195 and coaxially about the axle 175. The first end of the resilient member 205 is coupled to the housing and the second end of the resilient member 205 is coupled to the plate 210. The resilient member 205 is configured to bias the first pedal 145 in the first pedal first position 150. The resilient member may also be configured to rotate the spool 190 to uptake, or wind the belt 200 thereabouts, when the first pedal 145 is moved from the first pedal second position 155 to the first pedal first position 150.

The drive apparatus 100 also includes a second unidirectional clutch mechanism 215. The unidirectional clutch 215 mechanism includes a unidirectional clutch bearing 220. The unidirectional clutch bearing 220 is coaxially disposed within and coupled to a spool 225. The axle 175 is coaxially disposed within the spool 225 and clutch bearing 220. The unidirectional clutch bearing 220 is configured to operably engage the axle 175 when the bearing 220 is rotated in one direction and disengage the axle 175 when the bearing 220 is rotated in the opposite direction. A belt 230 extends from the spool 225 to the second pedal 160. While the illustrative embodiment employs a belt 230, it will be appreciated that any suitable device or mechanism may be employed and remain within the scope of the present disclosure; for example, and without limitation, a rope, sting, spring or any other suitable device or mechanism may extend from the spool 225 to the second pedal 160.

When a user applies a linear force to the second pedal 160 to move the second pedal 160 from the second pedal first position 165 to the second pedal second position 170, the belt 230 is unwound from the spool 225 whereby the spool 225 and the clutch bearing 220 are rotated in a direction that causes the clutch bearing 220 to engage the axle 175 such that the axle 175 is rotated and a rotary propulsive force is imparted to the rear wheel 130. When a user applies a linear force to the second pedal 160 to move the second pedal 160 from the second pedal second position 170 to the second pedal first position 165, the clutch bearing 220 disengages the axle 175 and the axle 175 is not rotated therefrom.

In one embodiment, the apparatus 100 includes a second biasing system 255 comprising a housing 235, a resilient member 245 and a plate 240. The housing 235 extends from the spool 225. The interior of the housing 235 is encased by the plate 240. The plate 240 is rigidly coupled to the rear portion of the second track member 140 such that the plate does not rotate when the axle is rotating. While the plate 240 is rigidly coupled to the rear of the second track 145, it will be appreciated that the plate 240 may be coupled to any stationary (relative to the rotation of the spool 225) item or device and remain within the scope of the present disclosure. The resilient member 245, such as a spiral-torsion spring, is disposed within the housing 235 and coaxially about the axle 175. The first end of the resilient member 245 is coupled to the housing and the second end of the resilient member 245 is coupled to the plate 240. The resilient member 245 is configured to bias the second pedal 160 in the second pedal first position 165. The resilient member may also be configured to rotate the spool 225 to uptake, or wind the belt 230 thereabouts, when the second pedal 160 is moved from the second pedal second position 170 to the second pedal first position 165.

The drive apparatus 100 may be operated in a reciprocating manner whereby a user may propel the transportation device forward. For example, a user may engage each pedal 145, 160 with his or her feet. The user may then apply a linear force to the first pedal 145 to move the first pedal 145 from the first pedal first position 150 to the first pedal second position 155 whereby the first unidirectional clutch mechanism 180 will operate as previously discussed and the device 110 will be propelled forward by rotation of the rear wheel 130. As the user is moving the first pedal 145 from the first pedal first position 150 to the first pedal second position 155, the user may be simultaneously moving the second pedal 160 from the second pedal second position 170 to the second pedal first position 165 whereby the second belt 230 is wound about the spool 225. Once the first pedal 145 reaches the first pedal second position 155 and the second pedal 160 reaches the second pedal first position 165, the user may then move the second pedal 160 from the first position 165 to the second position 170 thereby propelling the device 110 forward per rotation of the real wheel 130, as previously discussed, and simultaneously move the first pedal 145 from the second position 155 to the first position 150 whereby the first belt 200 is wound about the spool 185.

In one embodiment, the pedals 145, 160 may be functionally linked to a reciprocating assembly 260. The reciprocating assembly 260 may include a first pulley 265 coupled to the device 110 at or near the front frame 115 and a second pulley 270 coupled to the rear portion of the device 110. A belt 275 may link the pulleys 265, 270 together. The first pedal 145 may be coupled to the upper portion of the belt 275 (as shown in FIG. 1) and the second pedal 160 may be coupled to the lower portion of the belt 275 (as shown in FIG. 1). Thus, when one of the pedals 145, 160 receives a linear force moving the pedal 145, 160 from the first position 150, 165 to the second position 155, 170, the other pedal 145, 160 moves in the opposite direction, i.e. from the second position 155, 170 to the first position 150, 165. While each pulley 265, 270 is shown as having an axis of rotating substantially parallel to the rotational axis of each wheel 125, 130, it will be appreciated that the pulleys 265, 270 may have any suitable orientation and remain within the scope of the present disclosure.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A drive apparatus for converting a substantially linear drive force to a rotary propulsive force, the apparatus comprising:
a track member;
a pedal slidingly engaging the track member, the pedal movable between first and second positions;
an axle; and
a unidirectional clutch mechanism coupled to the pedal and coupled the axle, wherein the clutch operably engages the axle when a substantially linear force is applied in moving the pedal from the first position to the second position such that a rotary propulsive force is produced by the axle.

2. The drive apparatus of claim 1 wherein the clutch mechanism disengages the axle when a substantially linear force is applied in moving the pedal from the second position to the first position.

3. The drive apparatus of claim 1 wherein the clutch is coupled to the pedal via a belt.

4. The drive apparatus of claim 3 further comprising a spool for engaging and receiving the belt.

5. The drive apparatus of claim 1 further comprising a biasing system operable to bias the pedal in the second pedal position.

6. The drive apparatus of claim 5 wherein the biasing system is also capable of assisting the pedal movement to the pedal first position when a substantially linear force is applied in moving the pedal from the second position to the first position.

7. The drive apparatus of claim 5 wherein the biasing system comprises a resilient member for biasing the pedal in the first pedal position.

8. The drive apparatus of claim 7 wherein the resilient member is a spiral-torsion spring.

9. A drive apparatus for converting a substantially linear drive force to a rotary propulsive force, the apparatus comprising:
a first track member;
a first pedal slidingly engaging the track member, the first pedal movable between first and second positions;
a second track member;
a second pedal slidingly engaging the track member, the second pedal movable between first and second positions;
an axle;
a first unidirectional clutch mechanism coupled to the first pedal and coupled the axle, wherein the first clutch operably engages the axle when a substantially linear force is applied in moving the first pedal from the first position to the second position such that a rotary propulsive force is produced by the axle; and
a second unidirectional clutch mechanism coupled to the second pedal and coupled the axle, wherein the second clutch operably engages the axle when a substantially linear force is applied in moving the second pedal from the first position to the second position such that a rotary propulsive force is produced by the axle.

10. The drive apparatus of claim 9 wherein the first clutch mechanism disengages the axle when a substantially linear force is applied in moving the first pedal from the second position to the first position.

11. The drive apparatus of claim 9 wherein the second clutch mechanism disengages the axle when a substantially linear force is applied in moving the second pedal from the second position to the first position.

12. The drive apparatus of claim 9 wherein the first clutch is coupled to the first pedal via a first belt and wherein the second clutch is coupled to the second pedal via a second belt.

13. The drive apparatus of claim 12 further comprising a first spool for engaging the first belt and a second spool for engaging the second belt.

14. The drive apparatus of claim 9 further comprising a first biasing system operable to bias the first pedal in the first pedal second position and a second biasing system operable to bias the second pedal in the second pedal second position.

15. The drive apparatus of claim 14 wherein each of the first and second biasing systems comprise a resilient member for biasing the respective pedals in the respective first pedal positions.

16. The drive apparatus of claim 15 wherein the resilient member is a spiral-torsion spring.

17. The drive apparatus of claim 9 wherein each of the first and second pedals are functionally linked to a reciprocating assembly such that when one of the first and second pedals receives a substantially linear force in one direction, the other of the first and second pedals moves in the opposite direction.

18. The drive apparatus of claim 17 wherein the reciprocating assembly includes at least one pulley and a belt, wherein each of the first and second pedals is coupled to the belt.

19. The drive apparatus of claim 18 wherein the belt includes a first portion and a second portion, wherein the first pedal is coupled to the first portion and the second pedal is coupled to the second portion.

20. The drive apparatus of claim 18 wherein each pulley has an axis of rotation wherein the axis of rotation is substantially parallel to the axle.
